(19) United States
(12) Patent Application Publication
(10) Pub. No.: US 2025/0338032 A1
(43) Pub. Date: Oct. 30, 2025

(54) PHOTOELECTRIC CONVERSION DEVICE

(71) Applicant: CANON KABUSHIKI KAISHA, Tokyo (JP)

(72) Inventors: HIDEO KOBAYASHI, Tokyo (JP); TAKANORI SUZUKI, Tokyo (JP); HAJIME HAYAMI, Kanagawa (JP)

(21) Appl. No.: 19/184,547

(22) Filed: Apr. 21, 2025

(30) Foreign Application Priority Data
Apr. 25, 2024 (JP) 2024-071611

(51) Int. Cl. H04N 25/42; H04N 23/12; H04N 25/705; H04N 25/709; H04N 25/779; H04N 25/78; H04N 25/79

(52) U.S. Cl. CPC H04N 25/42; H04N 23/12; H04N 25/705; H04N 25/709; H04N 25/779; H04N 25/78; H04N 25/79

(57) ABSTRACT

A photoelectric conversion device including a plurality of pixels arranged in a plurality of columns, a first signal line arranged corresponding to each of the plurality of columns, the first signal line used to read out a signal from a first pixel group out of the plurality of pixels in a first scanning mode, a second signal line arranged corresponding to each of the plurality of columns, the second signal line used to read out a signal from a second pixel group out of the plurality of pixels in a second scanning mode, and a potential control unit configured to supply a predetermined potential to the second signal line in a period in which readout in the first scanning mode is performed and readout in the second scanning mode is not performed.

### BACKGROUND OF THE INVENTION

### Field of the Invention

The present disclosure relates to a photoelectric conversion device.

### Description of the Related Art

International Publication No. WO2015/133323 discloses an imaging element in which a plurality of signal lines are arranged in one pixel column. Different readout modes are allocated to the plurality of signal lines, respectively.

In a photoelectric conversion device disclosed in International Publication No. WO2015/133323, improvement in quality of an output signal is required.

### SUMMARY OF THE INVENTION

Therefore, an object of the present disclosure is to provide a photoelectric conversion device capable of improving signal quality.

According to one disclosure of the present specification, there is provided a photoelectric conversion device including a plurality of pixels arranged in a plurality of columns, a first signal line arranged corresponding to each of the plurality of columns, the first signal line used to read out a signal from a first pixel group out of the plurality of pixels in a first scanning mode, a second signal line arranged corresponding to each of the plurality of columns, the second signal line used to read out a signal from a second pixel group out of the plurality of pixels in a second scanning mode, and a potential control unit configured to supply a predetermined potential to the second signal line in a period in which readout in the first scanning mode is performed and readout in the second scanning mode is not performed.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is a circuit diagram of a pixel according to the first embodiment.

FIG. 3 is a circuit diagram of a current source according to the first embodiment.

FIG. 4 is a timing chart illustrating operation of the photoelectric conversion device according to the first embodiment.

FIG. 5 is a timing chart illustrating operation of the photoelectric conversion device according to the first embodiment.

FIG. 6 is a schematic diagram of the stacked-type photoelectric conversion device according to the first embodiment.

FIG. 7 is a block diagram illustrating a schematic configuration of a photoelectric conversion device according to a second embodiment.

FIG. 8 is a block diagram illustrating a configuration of one row of a photoelectric conversion device according to a third embodiment.

FIG. 9 is a timing chart illustrating operation of the photoelectric conversion device according to the third embodiment.

FIG. 10 is a timing chart illustrating operation of a photoelectric conversion device according to a fourth embodiment.

FIG. 11 is a block diagram of equipment according to a fifth embodiment.

FIG. 12A and FIG. 12B are block diagrams of equipment according to a sixth embodiment.

### DESCRIPTION OF THE EMBODIMENTS

Preferred embodiments of the present invention will now be described in detail in accordance with the accompanying drawings. The same or corresponding elements are labeled with the same reference signs throughout the drawings, and the description thereof may be omitted or simplified.

In first to fourth embodiments described below, an imaging device will mainly be described as an example of a photoelectric conversion device. However, the photoelectric conversion device in each embodiment is not limited to the imaging device, and can be applied to other photodetection devices based on photoelectric conversion. Examples of other photodetection devices include a ranging device and a photometric device. The ranging device may be, for example, a focus detecting device, a distance measurement device using a TOF (Time-Of-Flight), or the like. The photometric device may be a device that measures the amount of light incident on the device.

Note that the conductivity type of a transistor described in the following embodiments is an example, and the conductivity type is not limited only to the conductivity type described in the embodiments. The conductivity type can appropriately be changed from the conductivity type described in the embodiments, and the potentials of a gate, a source, and a drain of the transistor are appropriately changed with this change.

For example, in the case of a transistor that operates as a switch, the low level and the high level of the potential supplied to the gate described in the embodiments may be reversed along with the change of the conductivity type. In addition, the conductivity type of a semiconductor region described in the embodiments described below is an example, and the conductivity type is not limited only to the conductivity type described in the embodiments. The conductivity type described in the embodiments can appropriately be changed, and the potential of the semiconductor region is appropriately changed with this change.

In addition, in the following embodiments, connection between elements of a circuit may be described. In this case, even in a case where another element is interposed between the elements of interest, the elements of interest are treated as being connected to each other unless otherwise specified. For example, it is assumed that an element A is connected to one node of a capacitive element C having a plurality of nodes, and an element B is connected to another node thereof. Even in such a case, the element A and the element B are treated as being connected unless otherwise specified.

### First Embodiment

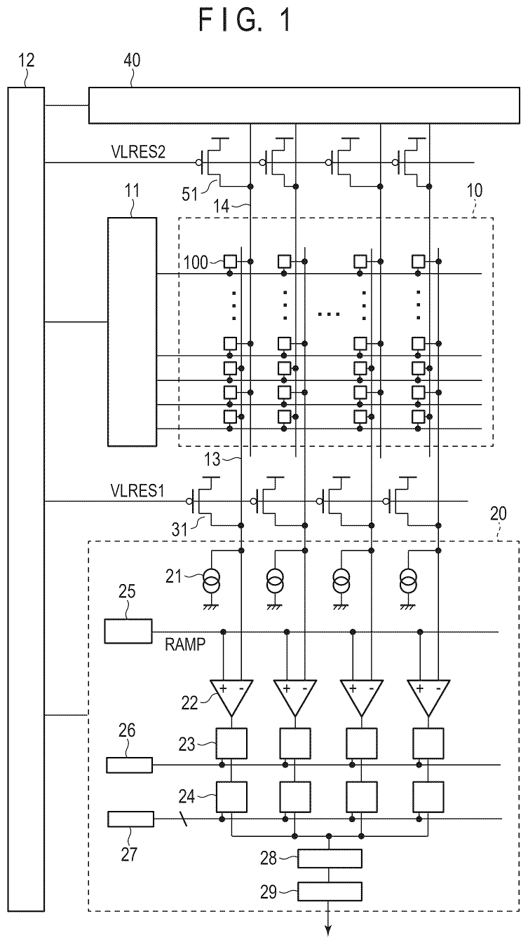

FIG. 1 is a block diagram illustrating a schematic configuration of a photoelectric conversion device according to the present embodiment. The photoelectric conversion device includes a pixel array 10, a vertical scanning circuit 11, a control circuit 12, and readout circuits 20 and 40.

The pixel array 10 includes a plurality of pixels 100 arranged to form a plurality of rows and a plurality of columns, each of which outputs a signal corresponding to incident light by photoelectric conversion. Each of the plurality of pixels 100 includes a photoelectric conversion unit that generates and accumulates signal charges on the basis of incident light. A microlens and a color filter may be arranged on the pixel 100.

The photoelectric conversion device includes a reference signal generation circuit 25, a counter 26, a horizontal scanning circuit 27, a processing circuit 28, and an output circuit 29. In addition, the photoelectric conversion device includes a column circuit corresponding to each column of the pixel array 10. The column circuit includes a current source 21, a comparator 22, a first memory 23, and a second memory 24.

The photoelectric conversion device includes a column signal line 13 (first signal line) and a column signal line 14 (second signal line). The column signal line 13 and the column signal line 14 are provided for each column of the pixels 100, and the pixels 100 in the same column output a signal to either the column signal line 13 or the column signal line 14. The pixels 100 (first pixel group) in the odd-numbered columns and the even-numbered rows are connected to the column signal line 13, and the pixels 100 (second pixel group) in the odd-numbered columns and the odd-numbered rows are connected to the column signal line 14. Readout in the pixels 100 in the odd-numbered columns and the even-numbered rows are performed by the readout circuit 20 on the lower side of FIG. 1 via the column signal line 13, and readout in the pixels 100 in the odd-numbered columns and the odd-numbered rows are performed by the readout circuit 40 on the upper side of FIG. 1 via the column signal line 14. The connection relationship between the pixels 100 in the even columns and the column signal lines is opposite to the connection relationship between the pixels 100 in the odd columns and the column signal lines. The number of column signal lines arranged for the pixels 100 in each column is not limited to two, and may be three or more. In addition, although four column circuits are illustrated in FIG. 1, a larger number of column circuits are actually arranged. Typically, the number of column circuits is several hundred to several thousand. Since the circuit configuration of the readout circuit 40 is substantially similar to that of the readout circuit 20, illustration thereof is omitted in FIG. 1. Furthermore, in the following description, description regarding the column signal line 14 and the readout circuit 40 may appropriately be omitted.

Furthermore, the photoelectric conversion device includes transistors 31 and 51 corresponding to each column of the pixel array 10. The transistors 31 and 51 are P-type metal oxide semiconductor (MOS) transistors. A drain (second main electrode) of the transistor 31 is connected to the column signal line 13, and a source (first main electrode) of the transistor 31 is connected to a potential line having a power supply potential. A control signal VLRES1 is input from the control circuit 12 into a gate of the transistor 31. A drain (second main electrode) of the transistor 51 is connected to the column signal line 14, and a source (first main electrode) of the transistor 51 is connected to the potential line having the power supply potential. A control signal VLRES2 is input from the control circuit 12 into a gate of the transistor 51. Note that the potential of the potential line to which the sources of the transistors 31 and 51 are connected may be a fixed potential other than the power supply potential.

The transistors 31 and 51 each function as a potential control unit that controls the column signal line to a predetermined potential so that the connected column signal lines are not in a floating state. The transistors 31 and 51 each function as a switch that controls connection between the potential line having the power supply potential and the column signal line. When the transistor 31 reaches the on state, a predetermined potential corresponding to the power supply potential is supplied from the drain of the transistor 31 to the column signal line 13. When the transistor 51 reaches the on state, a predetermined potential corresponding to the power supply potential is supplied from the drain of the transistor 51 to the column signal line 14.

The control circuit 12 controls the vertical scanning circuit 11, the readout circuits 20 and 40, and the transistors 31 and 51. As described above, the control circuit 12 outputs the control signals VLRES1 and VLRES2 to the transistors 31 and 51. In addition, the control circuit 12 supplies a control signal or the like instructing the operation timing of each unit in the vertical scanning circuit 11 and the readout circuits 20 and 40.

The vertical scanning circuit 11 includes a shift register, a gate circuit, a buffer circuit, and the like. The vertical scanning circuit 11 outputs a control signal to the pixel 100 on the basis of a vertical synchronization signal, a horizontal synchronization signal, a clock signal, or the like, and performs scanning to cause the pixel 100 to sequentially output a signal for each row.

The column circuit including the current source 21, the comparator 22, the first memory 23, and the second memory 24 processes a signal output from the pixel 100 via the column signal line 13. Specifically, the column circuit functions as an amplifier that amplifies a signal of the column signal line 13, and also functions as an analog-to-digital conversion unit (AD conversion unit) that converts an analog signal input via the column signal line 13 into a digital signal. The current source 21 is connected to the column signal line 13 and functions as a load circuit that supplies a driving current for signal output from the pixel 100. The comparator 22 compares a reference signal with the signal of the column signal line 13. The first memory 23 and the second memory 24 hold count signals according to the comparison result by the comparator 22.

The comparator 22 includes a differential amplifier circuit and the like, and has an inverting input node, a non-inverting input node, and an output node. The inverting input node is connected to the column signal line 13, and a reference signal RAMP is input from the reference signal generation circuit 25 to the non-inverting input node. The comparator 22 compares the reference signal RAMP with the signal from the pixel 100, and outputs a comparison signal indicating a comparison result from the output node.

The reference signal generation circuit 25 generates the reference signal RAMP (ramp signal) in which the potential changes depending on time on the basis of a clock pulse output from the control circuit 12 or a not-illustrated clock generation circuit. The reference signal generation circuit 25 can be configured using various methods such as a capacity charge/discharge method, a DAC method, and a current steering method. The reference signal RAMP may be an up-slope in which the potential increases with time or a down-slope in which the potential decreases with time. Furthermore, the reference signal RAMP may include a plurality of slope waveforms having different potential change rates per unit time.

The counter 26 counts clock pulses output from the control circuit 12 or the not-illustrated clock generation circuit, and performs count-up or count-down of a count signal which is a digital signal having a predetermined number of bits. The control circuit 12 or the clock generation circuit includes an oscillation circuit or the like, and supplies a clock pulse to the counter 26. The counter 26 starts counting the number of the clock pulses at the same time as the start of the potential change in the reference signal RAMP of the reference signal generation circuit 25, and outputs the clock signal to the first memory 23 via the wiring. At a time when the level of the comparison signal output from the comparator 22 changes, the first memory 23 holds the value of the clock signal input at the time. As a result, the signal from the pixel 100 is AD-converted. Thereafter, the signal from the first memory 23 is transferred to the second memory 24.

The horizontal scanning circuit 27 includes a shift register, a gate circuit, a buffer circuit, and the like. The horizontal scanning circuit 27 sequentially outputs a control signal to the second memory 24 in the corresponding column via the wiring corresponding to the column on the basis of the pulse of the control signal supplied from the control circuit 12. Therefore, the count value held in the second memory 24 is sequentially transferred to the processing circuit 28 for each column. The pulse of the control signal is a signal indicating a time to start horizontal transfer of the signal from the second memory 24 to the processing circuit 28.

The processing circuit 28 includes a digital signal processor and a memory, and has a function of performing processing such as digital correlated double sampling. The memory in the processing circuit 28 is used for temporary storage of a signal for the digital correlated double sampling. The signal held in the processing circuit 28 is output to the outside of the photoelectric conversion device by a method such as low voltage differential signaling (LVDS) via the output circuit 29 according to the control of the control circuit 12.

Note that FIG. 1 illustrates an example in which the count signal is input from the common counter 26 into the plurality of first memories 23, but the present invention is not limited thereto. For example, a plurality of counters 26 may be arranged so as to correspond to the plurality of first memories 23, respectively. In this case, a common clock pulse is input into the plurality of counters 26, and each of the plurality of counters 26 generates a count signal on the basis of the common clock pulse.

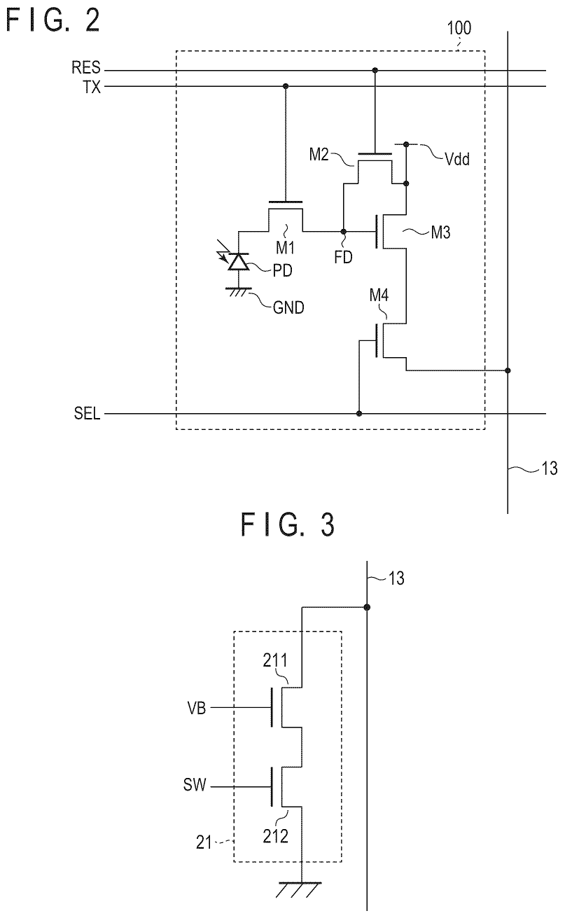

FIG. 2 is a circuit diagram of the pixel 100 according to the present embodiment. The pixel 100 may include a photoelectric conversion unit PD, a transfer transistor M1, a floating diffusion FD, a reset transistor M2, a source follower transistor M3, and a selection transistor M4. In the following description, unless otherwise specified, these transistors are assumed to be constituted by N-type MOS transistors. A reference potential (for example, a ground potential) is supplied to back gates (not illustrated) of these transistors. The drains of the reset transistor M2 and the source follower transistor M3 are connected to a potential line having the power supply potential Vdd. Note that a P-type MOS transistor may be used instead of the N-type MOS transistor. In this case, the potential of the control signal to be applied to the gate of the P-type MOS transistor is inverted with respect to the potential of the control signal to be applied to the gate of the N-type MOS transistor.

The photoelectric conversion unit PD is, for example, a photodiode, and generates charge by photoelectric conversion of incident light and accumulates the generated charge. Note that, instead of the photodiode, a configuration that generates a photoelectric effect, such as a photoelectric conversion film of an organic material and a photogate, may be used. The photoelectric conversion unit PD is provided with a microlens, and light condensed by the microlens is incident on the photoelectric conversion unit PD. Note that dark current noise can be reduced by adopting a buried photodiode for the photoelectric conversion unit PD.

The transfer transistor M1 is provided corresponding to the photoelectric conversion unit PD, and a control signal TX is input into the gate of the transfer transistor M1. When the control signal TX reaches the high level, the charge generated by the light reception in the photoelectric conversion unit PD and accumulated is transferred to the floating diffusion FD via the transfer transistor M1.

A power supply potential Vdd is applied to the drain of the source follower transistor M3. The source potential of the source follower transistor M3 changes according to the amount of charge transferred to the floating diffusion FD.

The selection transistor M4 is provided between the source follower transistor M3 and the column signal line 13. The selection transistors M4 of the pixels 100 in the even-numbered rows of one column are connected to the common column signal line 13. The current source 21 and the source follower transistor M3 constitute a source follower. A control signal SEL is input into the gate of the selection transistor M4. When the control signal SEL reaches the high level, the selection transistor M4 outputs a signal corresponding to the source potential of the source follower transistor M3 to the column signal line 13.

The source of the reset transistor M2 is connected to the floating diffusion FD, and the power supply potential Vdd is applied to the drain of the reset transistor M2. A control signal RES is input into the gate of the reset transistor M2. When the control signal RES reaches the high level, the reset transistor M2 resets the potential of the floating diffusion FD.

FIG. 3 is a circuit diagram of the current source 21 according to the present embodiment. The current source 21 includes transistors 211 and 212. Each of the transistors 211 and 212 is assumed to be constituted by an N-type MOS transistor.

The drain of the transistor 211 is connected to the column signal line 13. The source of the transistor 211 is connected to the drain of the transistor 212. The source of the transistor 212 is connected to a potential line having the ground potential. A bias potential VB is supplied to the gate of the transistor 211. Therefore, the transistor 211 functions as a current source transistor. A control signal SW is input from the control circuit 12 to the gate of the transistor 212. Therefore, the transistor 212 functions as a switch that switches the on state and the off state of the current source 21. In the period in which readout via the column signal line 13 is not performed, the transistor 212 is set to the off state, whereby the current source 21 is switched to the off state, and power consumption can be lowered.

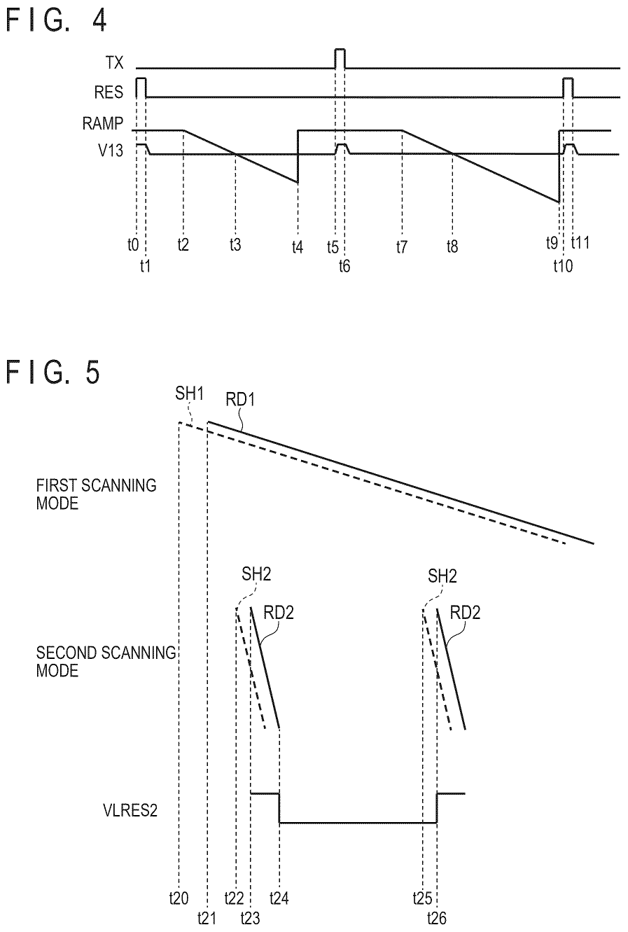

FIG. 4 is a timing chart illustrating operation of the photoelectric conversion device according to the present embodiment. FIG. 4 illustrates a readout method for one row of the photoelectric conversion device. FIG. 4 illustrates the potentials of the control signals TX and RES and the reference signal RAMP. In addition, “V13” in FIG. 4 indicates the potential of the column signal line 13.

In a period from time to to time t1, the control signal RES reaches the high level. As a result, the reset transistor M2 is turned on, and the floating diffusion FD is reset. Accordingly, the potential of the column signal line 13 is at the reset level.

At time t1, the control signal RES reaches the low level. As a result, the reset transistor M2 is turned off. At this time, the potential of the floating diffusion FD decreases due to the influence of the transition of the potential of the control signal RES via the parasitic capacitance between the gate and the source of the reset transistor M2. Accordingly, the potential of the column signal line 13 also decreases.

At time t2, a change in the potential of the reference signal RAMP starts. Further, at time t2, count-up of the count signal output from the counter 26 starts.

At time t3, the potential of the reference signal RAMP and the potential of the column signal line 13 become equal, and the output signal of the comparator 22 changes. The counter 26 measures time from time t2, at which the count-up starts, to time t3, at which the output signal of the comparator 22 changes. The first memory 23 holds the count signal from the counter 26. As a result, AD conversion of the reset level is performed. This AD conversion result is transferred from the first memory 23 to the second memory 24, and then transferred to the processing circuit 28 under the control of the horizontal scanning circuit 27. Thereafter, at time t4, the reference signal RAMP is reset and returns to the original potential.

In a period from time t5 to time t6, the control signal TX reaches the high level. As a result, the transfer transistor M1 is turned on, and the charge generated by photoelectric conversion is transferred from the photoelectric conversion unit PD to the floating diffusion FD. In the period from time t5 to time t6, the potential of the floating diffusion FD changes due to the transition of the control signal TX, and thus, the potential of the column signal line 13 also changes. FIG. 4 illustrates a waveform corresponding to a dark state in which no light is incident on the photoelectric conversion unit PD. Therefore, at and after time t6, the potential of the column signal line 13 settles in the reset level, which is similar to that at time t3. Note that, in a case where light is incident on the photoelectric conversion unit PD, the potential of the floating diffusion FD decreases according to the amount of the generated charge, and the potential of the column signal line 13 also decreases.

At time t6, the control signal TX reaches the low level. As a result, the transfer transistor M1 is turned off. At this time, the potential of the floating diffusion FD decreases due to the influence of the transition of the control signal TX via the parasitic capacitance between the gate and the source of the transfer transistor M1. Accordingly, the potential of the column signal line 13 also decreases.

At time t7, a change in the potential of the reference signal RAMP starts. Further, at time t7, count-up of the count signal output from the counter 26 starts.

At time t8, the potential of the reference signal RAMP and the potential of the column signal line 13 become equal, and the output signal of the comparator 22 changes. The counter 26 measures time from time t7, at which the count-up starts, to time t8, at which the output signal of the comparator 22 changes. The first memory 23 holds the count signal from the counter 26. As a result, AD conversion of the light signal level is performed. This AD conversion result is transferred from the first memory 23 to the second memory 24, and then transferred to the processing circuit 28 under the control of the horizontal scanning circuit 27. The processing circuit 28 performs digital correlated double sampling processing of calculating a difference between the light signal level and the reset level. Thereafter, at time t9, the reference signal RAMP is reset and returns to the original potential. Since the processing at time t10 and time t11 is similar to that at time t0 and time t1, the description thereof will be omitted.

FIG. 5 is a timing chart illustrating operation of the photoelectric conversion device according to the present embodiment. FIG. 5 illustrates a scanning method for sequentially reading a plurality of rows of the photoelectric conversion device. In the present embodiment, two pixel readout scanning modes are performed in parallel. These two readout scanning modes are referred to as a first scanning mode and a second scanning mode. That is, at least a part of a period in which a signal is read out in the first scanning mode overlaps with at least a part of a period in which a signal is read out in the second scanning mode. In the present embodiment, the period in which the scanning in the first scanning mode is performed is longer than the period in which the scanning in the second scanning mode is performed. That is, the frame rate in the second scanning mode is higher than the frame rate in the first scanning mode. In addition, a plurality of periods in which the scanning in the second scanning mode is performed are included in a period in which the scanning in the first scanning mode is performed once. In a period between the two scanning periods in the second scanning mode, the column signal line 14 is not used for readout.

The column signal line 13 is allocated to the readout in the first scanning mode, and the column signal line 14 is allocated to the readout in the second scanning mode. Therefore, signals are read out from the plurality of pixels 100 to the readout circuit 20 via the column signal line 13 in the first scanning mode, and signals are read out from the plurality of pixels 100 to the readout circuit 40 via the column signal line 14 in the second scanning mode.

In this manner, the different column signal lines are allocated to the two reading scanning modes, respectively. Thus, even in a case where the readout processes of the signals in the two reading scanning modes are performed in parallel, the signals in the other scanning modes are not simultaneously output to one column signal line. Therefore, a readout method in which the two reading scanning modes are performed in parallel can be achieved easily.

The horizontal direction in FIG. 5 indicates the passage of time in one vertical scanning period. The vertical direction of “first scanning mode” and “second scanning mode” in FIG. 5 schematically illustrates the position in the row direction of the pixel 100 on which the processing is performed, and the vertical direction of “VLRES2” in FIG. 5 illustrates the potential of the control signal VLRES2. That is, the “first scanning mode” in FIG. 5 indicates a temporal change of a row in which a shutter operation SH1 and a readout operation RD1 are performed in the first scanning mode. The “second scanning mode” in FIG. 5 indicates a temporal change of a row in which a shutter operation SH2 and a readout operation RD2 are performed in the second scanning mode.

At time t20, the shutter operation SHI starts. More specifically, in the pixel 100 connected to the column signal line 13, the reset transistor M2 and the transfer transistor Ml are turned on, whereby the photoelectric conversion unit PD is reset. In the shutter operation SH1, this reset operation is sequentially performed for each row.

At time t21, the readout operation RD1 starts. More specifically, a signal is read out from the pixel 100 via the column signal line 13 by the operation illustrated in FIG. 4. In the readout operation RD1, this reset operation is sequentially performed for each row.

At time t22, the shutter operation SH2 starts. More specifically, in the pixel 100 connected to the column signal line 14, the reset transistor M2 and the transfer transistor M1 are turned on, whereby the photoelectric conversion unit PD is reset. In the shutter operation SH2, this reset operation is sequentially performed. However, in the shutter operation SH2, unlike in the shutter operation SH1, the photoelectric conversion units PD are simultaneously reset in the pixels 100 in the plurality of rows. The number of rows of the photoelectric conversion units PD to be simultaneously reset may be, for example, eight, but is not limited thereto, and may be, for example, an integer of two or more. Examples of the number of rows of the photoelectric conversion units PD to be simultaneously reset include two rows, three rows, four rows, six rows, 12 rows, and 16 rows.

At time t23, the readout operation RD2 starts. More specifically, a signal is read out from the pixel 100 via the column signal line 14 by the operation illustrated in FIG. 4. In the readout operation RD2, this reset operation is sequentially performed. However, in the readout operation RD2, unlike in the readout operation RD1, signals are simultaneously read out from the pixels 100 in a plurality of rows. The number of rows of the photoelectric conversion units PD in which the readout is simultaneously performed may be, for example, eight, but is not limited thereto, and may be, for example, an integer of two or more. Examples of the number of rows of the photoelectric conversion units PD in which the readout is simultaneously performed include two rows, three rows, four rows, six rows, 12 rows, and 16 rows. Furthermore, for example, thinning readout in which readout is performed in some of the eight rows may be applied. For example, readout in one of the eight rows may be performed, readout in two of the eight rows may be performed, or readout in four of the eight rows may be performed.

At time t24, the readout operation RD2 ends. In addition, at the same time as the end of the readout operation RD2, the control signal VLRES2 transitions from the high level to the low level. As a result, the transistor 51 reaches the on state, and the column signal line 14 reaches a state of being reset to the power supply potential.

A period from time t23 to time t24 in which a signal is read out in the second scanning mode overlaps with a period in which a signal is read out in the first scanning mode. Therefore, in the period from time t23 to time t24, signal readout in the two scanning modes is performed in parallel.

At time t25, the shutter operation SH2 starts again. Then, at time t26, the readout operation RD2 starts again. At the same time as the start of the readout operation RD2, the control signal VLRES2 transitions from the low level to the high level. As a result, the transistor 51 reaches the off state, and the reset of the column signal line 14 is released.

In the period from time t24 to time t26, since the readout operation RD2 in the second scanning mode is not performed, the column signal line 14 is not used. At this time, if the column signal line 14 is in a floating state, the potential of the column signal line 14 may become unstable, and thus the potential of the column signal line 13 may be affected via the coupling capacitance between the column signal line 14 and the column signal line 13. Conversely, in the present embodiment, control is performed such that the column signal line 14 is not in the floating state by the column signal line 14 being in the reset state in the period from time t24 to time t26. As a result, the potential of the column signal line 14 is stabilized, and the quality of the output signal can be improved. Therefore, according to the present embodiment, a photoelectric conversion device capable of improving signal quality is provided.

In addition, in the period from time t24 to time t26, since no signal is read via the column signal line 14, the circuit components such as the current source and the comparator in the readout circuit 40 connected to the column signal line 14 can be in a power saving state. Therefore, according to the present embodiment, the power consumption of the photoelectric conversion device can be reduced.

Furthermore, in the present embodiment, signal readout processes in two scanning modes having different numbers of pixels to be read out are performed in parallel. Accordingly, a plurality of image signals having different frame rates can be acquired.

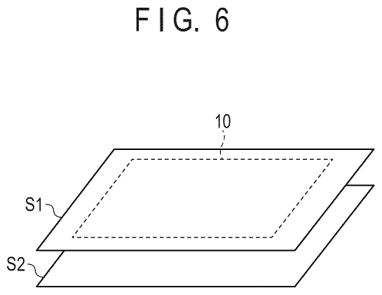

The photoelectric conversion device of the present embodiment may be arranged in one substrate, or may be a stacked type in which a plurality of substrates are stacked on each other. FIG. 6 is a schematic diagram of the stacked-type photoelectric conversion device according to the present embodiment. As illustrated in FIG. 6, in the photoelectric conversion device, a pixel substrate S1 (first substrate) in which the pixel array 10 is arranged and a circuit substrate S2 (second substrate) in which another circuit is arranged are stacked. That is, the transistors 31 and 51 are arranged in the circuit substrate S2. As illustrated in FIG. 2, the transistors included in the pixel 100 are all N-type MOS transistors. Therefore, by arranging the transistors 31 and 51, which are P-type MOS transistors, in the circuit substrate S2, the P-type MOS transistors are not arranged in the pixel substrate S1, so that the manufacturing process of the pixel substrate S1 can be simplified. Although FIG. 6 illustrates an example of a stacked photoelectric conversion device in which two substrates are stacked, the number of substrates to be stacked may be three or more.

Note that the transistors 31 and 51 are not necessarily P-type MOS transistors, and may be N-type MOS transistors, for example. In this case, when the N-type MOS transistors are turned on, the column signal line 13 or the column signal line 14 is connected to a potential line having the ground potential. In this case, a similar effect can be obtained. However, in order to perform this operation, unless all the selection transistors M4 in the plurality of pixels 100 connected to the column signal line 13 or the column signal line 14 are turned off, a large current may flow from the power supply potential of the pixels 100 to the ground potential. Therefore, it is desirable that the transistors 31 and 51 are P-type MOS transistors, and a power supply potential is supplied to the column signal line 13 or the column signal line 14.

### Second Embodiment

A photoelectric conversion device according to a second embodiment will be described. In the description of the present embodiment, components having the same functions as those of the first embodiment are labeled with the same reference signs, and the detailed description may be omitted or simplified.

The photoelectric conversion device of the present embodiment is a modification example in which the functions of the transistors 31 and 51 of the first embodiment are fulfilled by dummy pixels. The other points are substantially similar to those of the first embodiment, and thus description thereof is omitted.

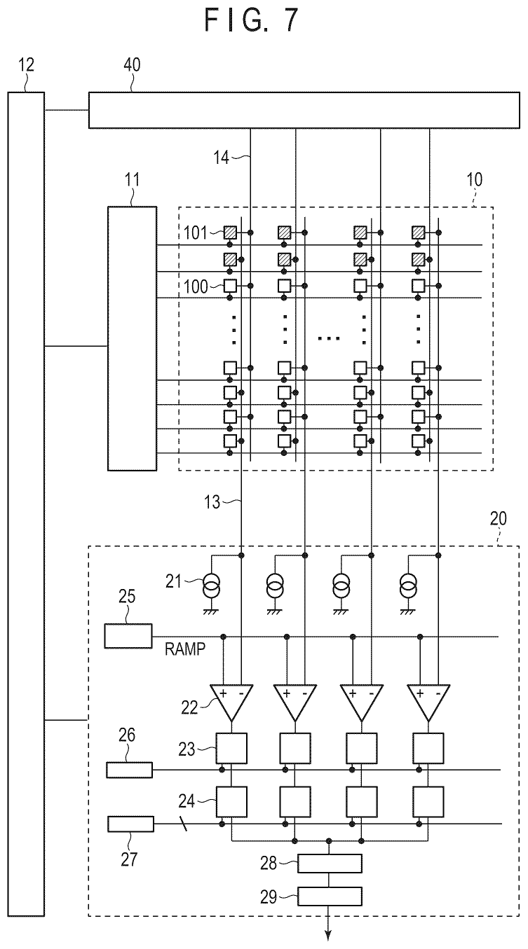

As illustrated in FIG. 7, in the photoelectric conversion device of the present embodiment, a plurality of dummy pixels 101 are arranged in the pixel array 10. In the example of FIG. 7, the dummy pixels 101 are arranged over two rows including the first row and the second row. Further, in the photoelectric conversion device of the present embodiment, the transistors 31 and 51 of the first embodiment are not arranged.

The dummy pixels 101 in the first rows of the odd-numbered columns are connected to the column signal line 14, and the dummy pixels 101 in the second rows of the odd-numbered columns are connected to the column signal line 13. The dummy pixels 101 in the first rows of the odd-numbered columns each output a signal of a fixed potential not depending on incident light to the column signal line 14, and the dummy pixels 101 in the second rows of the odd-numbered columns each output a signal of a fixed potential not depending on incident light to the column signal line 13. The connection relationship between the dummy pixels 101 in the even columns and the column signal lines is opposite to the connection relationship between the dummy pixels 101 in the odd columns and the column signal lines. That is, the dummy pixels 101 each function as a potential control unit that supplies a predetermined potential so that the column signal lines 13 and 14 are not in the floating state. Examples of the configuration of the dummy pixel 101 include an optical black pixel having a similar circuit configuration to that in FIG. 2, in which the photoelectric conversion unit PD is shielded from light by a metal film or the like. In this case, the dummy pixel 101 outputs a black level signal to the column signal line 13 or the column signal line 14.

In the present embodiment, in the period from time t24 to time t26 in FIG. 5, in which the readout operation RD2 in the second scanning mode is not performed, while the control signal VLRES2 reaches the low level, the selection transistor M4 of the dummy pixel 101 reaches the high level. As a result, the selection transistor M4 of the dummy pixel 101 is turned on, and a signal of a fixed potential is output from the dummy pixel 101 to the column signal line 14. As a result, control is performed such that the column signal line 14 is not in the floating state. Therefore, according to the present embodiment, as well as the first embodiment, a photoelectric conversion device capable of improving signal quality is provided. In addition, in the present embodiment, the transistors 31 and 51 of the first embodiment can be omitted.

Note that, in the configuration of the present embodiment, when the current flowing through column signal line 14 becomes zero, the source follower transistor M3 reaches the off state, and the column signal line 14 reaches the floating state. In order to avoid this, a constant current needs to flow through the column signal line 14. Accordingly, in the configuration of the present embodiment, power consumption is larger than that in the configuration of the first embodiment using the transistors 31 and 51. Therefore, from the viewpoint of power consumption, the configuration of the first embodiment using the transistors 31 and 51 may be more effective.

### Third Embodiment

A photoelectric conversion device according to a third embodiment will be described. In the description of the present embodiment, components having the same functions as those of the first embodiment are labeled with the same reference signs, and the detailed description may be omitted or simplified. The photoelectric conversion device of the present embodiment is a modification example in which four column signal lines are arranged in one column. Differences from the first embodiment will be described below.

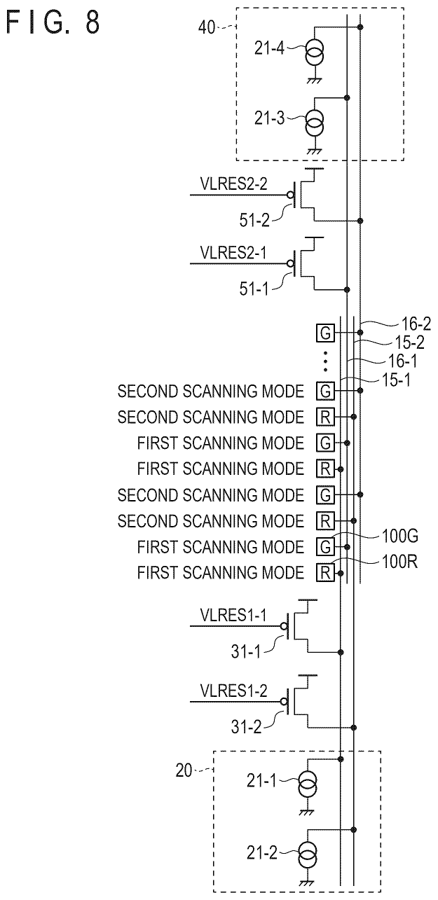

FIG. 8 is a block diagram illustrating a configuration of one row of the photoelectric conversion device according to the present embodiment. FIG. 8 illustrates pixels, transistors, current sources, and column signal lines for only one column extracted from the overall configuration of the photoelectric conversion device illustrated in FIG. 1. The configurations of the other blocks are similar to those in FIG. 1, and description thereof is omitted.

As illustrated in FIG. 8, the photoelectric conversion device of the present embodiment includes four column signal lines 15-1, 15-2, 16-1, and 16-2 in one column. In addition, the photoelectric conversion device according to the present embodiment includes transistors 31-1, 31-2, 51-1, and 51-2 and current sources 21-1, 21-2, 21-3, and 21-4. The transistors 31-1, 31-2, 51-1, and 51-2 are P-type MOS transistors.

In the column illustrated in FIG. 8, red pixels 100R having sensitivity to red (first color) light and green pixels 100G having sensitivity to green (second color) light are alternately arranged. A red color filter is arranged in the red pixel 100R, and a green color filter is arranged in the green pixel 100G. Further, a part of the red pixel 100R is read out in the first scanning mode, and the other part is read out in the second scanning mode. A part of the green pixel 100G is read out in the first scanning mode, and the other part is read out in the second scanning mode. Note that the red pixels 100R and the green pixels 100G are arranged in the column illustrated in FIG. 8, but these colors are examples, and pixels of other colors may be arranged. For example, green pixels and blue pixels may be arranged in one column.

The column signal line 15-1 (first signal line) is allocated to the readout of the red pixels 100R (first pixel group) in the first scanning mode, and the column signal line 15-2 (second signal line) is allocated to the readout of the red pixels 100R (second pixel group) in the second scanning mode. The column signal line 16-1 (third signal line) is allocated to the readout of the green pixels 100G (third pixel group) in the first scanning mode, and the column signal line 16-2 (fourth signal line) is allocated to the readout of the green pixels 100G (fourth pixel group) in the second scanning mode. In FIG. 8, “first scanning mode” is written for the red pixels 100R and the green pixels 100G in which the readout is performed in the first scanning mode. Furthermore, “second scanning mode” is written for the red pixels 100R and the green pixels 100G that are read out in the second scanning mode.

The column signal lines 15-1 and 15-2 extend downward in FIG. 8 and are connected to the readout circuit 20. The column signal lines 16-1 and 16-2 extend upward in FIG. 8 and are connected to the readout circuit 40. Therefore, the signal of the red pixel 100R is read out by the readout circuit 20 in both the first scanning mode and the second scanning mode, and the signal of the green pixel 100G is read out by the readout circuit 40 in both the first scanning mode and the second scanning mode. In this manner, by making the readout direction different according to the color of the pixel, mixing of different colors can be reduced.

The current sources 21-1, 21-2, 21-3, 21-4 are connected to the column signal lines 15-1, 15-2, 16-1, 16-2, respectively. The drains of the transistors 31-1, 31-2, 51-1, and 51-2 are connected to the column signal lines 15-1, 15-2, 16-1, and 16-2, respectively. The sources of the transistors 31-1, 31-2, 51-1, and 51-2 are connected to a potential line having the power supply potential. The control signals VLRES1-1, VLRES1-2, VLRES2-1, and VLRES2-2 are input from the control circuit 12 to the gates of the transistors 31-1, 31-2, 51-1, and 51-2, respectively.

The shutter operation and the readout operation in the first scanning mode and the shutter operation and the readout operation in the second scanning mode are performed similarly to those in FIG. 5. In a period in which the readout operation in the second scanning mode is not performed, the column signal lines 15-2 and 16-2 are not used. In this period, the control signals VLRES1-2 and VLRES2-2 reach the low level, and the transistors 31-2 and 51-2 reach the on state. Due to this operation, the column signal lines 15-2 and 16-2 reach the reset state. That is, control is performed such that the column signal lines 15-2 and 16-2 are not in the floating state. Therefore, according to the present embodiment, as well as the first embodiment, a photoelectric conversion device capable of improving signal quality is provided.

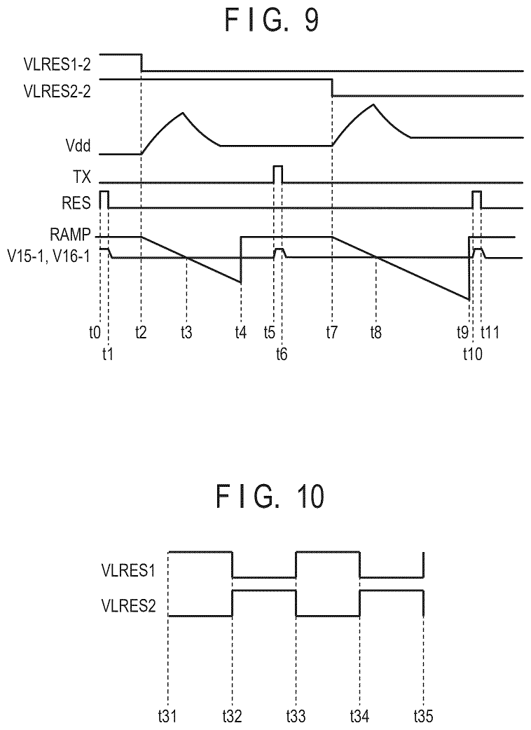

Here, the time when the control signal VLRES1-2 reaches the low level and the time when the control signal VLRES2-2 reaches the low level may be the same or different. An example in which the time when the control signal VLRES1-2 reaches the low level and the time when the control signal VLRES2-2 reaches the low level are different will be described with reference to FIG. 9.

FIG. 9 is a timing chart illustrating operation of the photoelectric conversion device according to the present embodiment. FIG. 9 illustrates a readout method for one row of the photoelectric conversion device. FIG. 9 illustrates the potentials of the control signals VLRES1-2, VLRES2-2, TX, and RES, the power supply potential Vdd, and the reference signal RAMP. In addition, “V15-1, V16-1” in FIG. 9 indicates the potentials of the column signal lines 15-1 and 16-1. The potentials of the control signals TX and RES, the reference signal RAMP, and the column signal lines 15-1 and 16-1 are substantially similar to those illustrated in FIG. 4, and thus the description thereof is omitted.

At time t2 (first time), the control signal VLRES1-2 transitions from the high level to the low level. As a result, the transistor 31-2 reaches the on state, and the column signal line 15-2 reaches a state of being reset to the power supply potential. Thereafter, at time t7 (second time), the control signal VLRES2-2 transitions from the high level to the low level. As a result, the transistor 51-2 reaches the on state, and the column signal line 16-2 reaches a state of being reset to the power supply potential.

When the column signal lines 15-2 and 16-2 are reset, the potentials of the column signal lines 15-2 and 16-2 increase to the power supply potential. Therefore, in the red pixel 100R connected to the column signal line 15-2 and the green pixel 100G connected to the column signal line 16-2, the source follower transistor M3 reaches the off state. In this state, the current flowing from the potential line having the power supply potential Vdd to the column signal lines 15-2 and 16-2 becomes zero or significantly decreases from the original current. As a result, as illustrated in FIG. 9, the power supply potential Vdd of the pixel can greatly fluctuate in the period after time t2 and the period after time t7. The fluctuation of the power supply potential Vdd is superimposed as noise on the signal read out via the column signal lines 15-1 and 16-1 in the first scanning mode, and thus may be a factor of degrading the signal quality.

Conversely, in the present embodiment, as illustrated in FIG. 9, the time when the column signal line 15-2 is reset to the power supply potential is different from the time when the column signal line 16-2 is reset to the power supply potential. More specifically, before time t3 at which the result of the AD conversion of the reset level is generated, the column signal line 15-2 is reset to the power supply potential, and thereafter, before time t8 at which the result of the AD conversion of the optical signal level is generated, the column signal line 16-2 is reset to the power supply potential. As a result, the fluctuation of the power supply potential Vdd affects both the result of the AD conversion of the reset level at time t3 and the result of the AD conversion of the optical signal level at time t8. The processing circuit 28 performs the digital correlated double sampling processing of calculating the difference between the result of the AD conversion of the optical signal level and the result of the AD conversion of the reset level, whereby the influence of the fluctuation of the power supply potential Vdd can be reduced. Therefore, in the example of FIG. 9, the signal quality can further be improved.

### Fourth Embodiment

A photoelectric conversion device according to a fourth embodiment will be described. In the description of the present embodiment, components having the same functions as those of the first embodiment are labeled with the same reference signs, and the detailed description may be omitted or simplified. The photoelectric conversion device according to the present embodiment is a modification example in which readout in the first scanning mode and readout in the second scanning mode are alternately performed. Differences from the first embodiment will be described below.

In the first embodiment, readout in the first scanning mode and readout in the second scanning mode are performed in parallel, but in the present embodiment, readout in the first scanning mode and readout in the second scanning mode are alternately performed. FIG. 10 is a timing chart illustrating operation of the photoelectric conversion device according to the present embodiment. FIG. 10 illustrates the control signals VLRES1 and VLRES2.

In a period from time t31 to time t32, the control signal VLRES1 is at the high level, and the control signal VLRES2 is at the low level. Therefore, the transistor 31 is in the off state, and the transistor 51 is in the on state. That is, in the period from time t3 1 to time t32, the signal in the first scanning mode is read out via the column signal line 13, and the column signal line 14 is in the reset state.

In a period from time t32 to time t33, the control signal VLRES1 is at the low level, and the control signal VLRES2 is at the high level. Therefore, the transistor 31 is in the on state, and the transistor 51 is in the off state. That is, in the period from time t32 to time t33, the signal in the second scanning mode is read out via the column signal line 14, and the column signal line 13 is in the reset state.

After time t33 as well, the period in which the signal is read out in the first scanning mode and the period in which the signal is read out in the second scanning mode are alternately repeated. The column signal line 14 is in the reset state in the period in which the signal is read out in the first scanning mode, and the column signal line 13 is in the reset state in the period in which the signal is read out in the second scanning mode. As a result, control is performed such that the unused column signal line is not in the floating state. Therefore, according to the present embodiment, as well as the first embodiment, a photoelectric conversion device capable of improving signal quality is provided. In the present embodiment, the period in which the signal is read out in the first scanning mode and the period in which the signal is read out in the second scanning mode do not overlap with each other. Accordingly, since the readout in the first scanning mode and the readout in the second scanning mode are not simultaneously performed, interference between the signal in the first scanning mode and the signal in the second scanning mode can be reduced.

### Fifth Embodiment

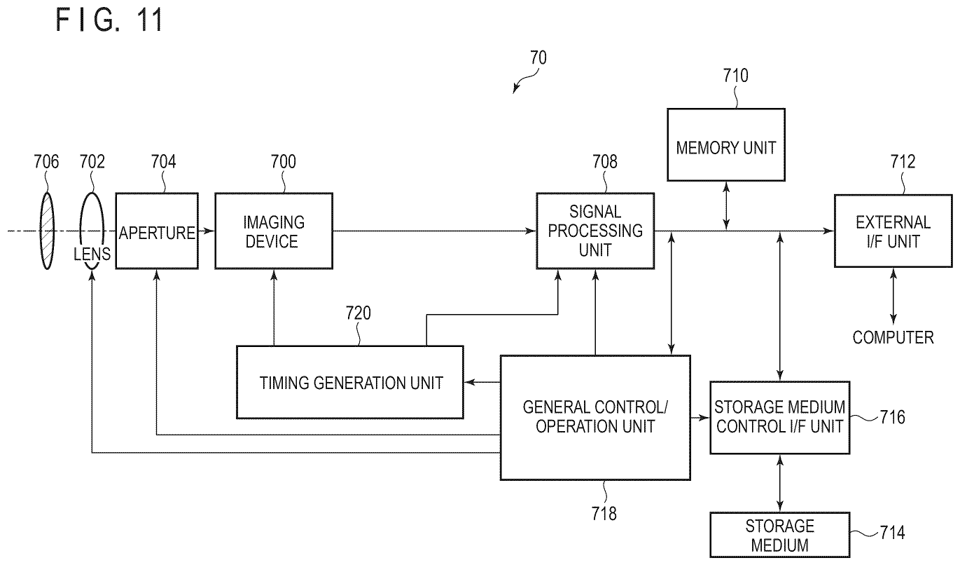

The photoelectric conversion device of the above embodiments can be applied to various equipment. Examples of the equipment include a digital still camera, a digital camcorder, a camera head, a copying machine, a facsimile, a mobile phone, a vehicle-mounted camera, an observation satellite, and a surveillance camera. FIG. 11 is a block diagram of a digital still camera as an example of equipment.

The equipment 70 illustrated in FIG. 11 includes a barrier 706, a lens 702, an aperture 704, and an imaging device 700 (an example of the photoelectric conversion device). The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. At least one of the barrier 706, the lens 702, and the aperture 704 is an optical device corresponding to the equipment. The barrier 706 protects the lens 702, and the lens 702 forms an optical image of an object on the imaging device 700. The aperture 704 varies the amount of light passing through the lens 702. The imaging device 700 is configured as in the above embodiments, and converts an optical image formed by the lens 702 into image data (image signal). The signal processing unit 708 performs various corrections, data compression, and the like on the image data output from the imaging device 700. The timing generation unit 720 outputs various timing signals to the imaging device 700 and the signal processing unit 708. The general control/operation unit 718 controls the entire digital still camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the photoelectric conversion device. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the imaging device 700 to an object.

### Sixth Embodiment

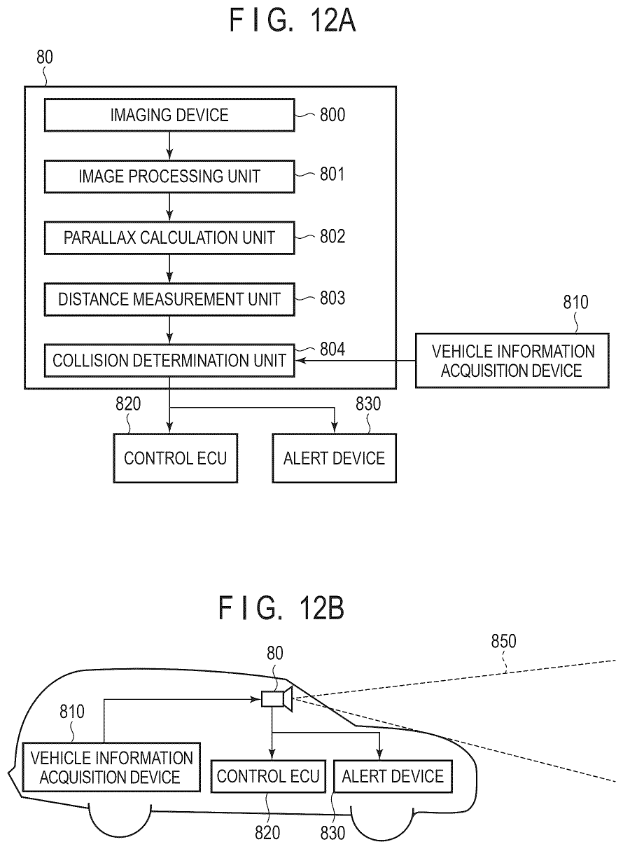

FIGS. 12A and 12B are block diagrams of equipment relating to the vehicle-mounted camera according to the present embodiment. The equipment 80 includes an imaging device 800 (an example of a photoelectric conversion device) of the above embodiments and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 12B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present invention.

The configuration of the pixel 100 is not limited to that illustrated in FIG. 2. For example, the capacitance of the floating diffusion FD of the pixel 100 may be variable. For example, one pixel 100 may have a plurality of photoelectric conversion units PD, and the plurality of photoelectric conversion units PD may share one floating diffusion FD. In addition, a plurality of photoelectric conversion units PD may be arranged corresponding to one microlens. In this case, it is possible to acquire a signal for ranging used for autofocus or the like by a phase difference detection method.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071611, filed Apr. 25, 2024, which is hereby incorporated by reference herein in its entirety.

What is claimed is:

1. A photoelectric conversion device comprising:
a plurality of pixels arranged in a plurality of columns;
a first signal line arranged corresponding to each of the plurality of columns, the first signal line used to read out a signal from a first pixel group out of the plurality of pixels in a first scanning mode;
a second signal line arranged corresponding to each of the plurality of columns, the second signal line used to read out a signal from a second pixel group out of the plurality of pixels in a second scanning mode; and
a potential control unit configured to supply a predetermined potential to the second signal line in a period in which readout in the first scanning mode is performed and readout in the second scanning mode is not performed.

2. The photoelectric conversion device according to claim 1, wherein the potential control unit includes a switch configured to control connection between a potential line having a fixed potential and the second signal line.

3. The photoelectric conversion device according to claim 2, wherein the fixed potential is a power supply potential.

4. The photoelectric conversion device according to claim 2,
wherein the switch includes a P-type MOS transistor having a first main electrode and a second main electrode,
wherein the first main electrode is connected to the potential line, and
wherein the second main electrode is connected to the second signal line.

5. The photoelectric conversion device according to claim 4,
wherein each of the plurality of pixels includes an N-type MOS transistor,
wherein the N-type MOS transistor is arranged in a first substrate, and
wherein the P-type MOS transistor is arranged in a second substrate stacked on the first substrate.

6. The photoelectric conversion device according to claim 1, wherein the potential control unit includes a dummy pixel configured to output a signal having a fixed potential to the second signal line.

7. The photoelectric conversion device according to claim 6, wherein the dummy pixel includes a light-shielded photoelectric conversion unit, and outputs a black level signal.

8. The photoelectric conversion device according to claim 1, wherein at least a part of a period in which the signal is read out in the first scanning mode overlaps with at least a part of a period in which the signal is read out in the second scanning mode.

9. The photoelectric conversion device according to claim 8, wherein the period in which the signal is read out in the first scanning mode is longer than the period in which the signal is read out in the second scanning mode.

10. The photoelectric conversion device according to claim 9, wherein a plurality of periods in which the signal is read out in the second scanning mode are included in the period in which the signal is read out in the first scanning mode.

11. The photoelectric conversion device according to claim 1, wherein a period in which the signal is read out in the first scanning mode and a period in which the signal is read out in the second scanning mode do not overlap with each other.

12. The photoelectric conversion device according to claim 11, wherein the period in which the signal is read out in the first scanning mode and the period in which the signal is read out in the second scanning mode are alternately repeated.

13. The photoelectric conversion device according to claim 11, wherein the potential control unit supplies the predetermined potential to the first signal line in a period in which readout in the second scanning mode is performed and readout in the first scanning mode is not performed.

14. The photoelectric conversion device according to claim 1 further comprising:
a third signal line arranged corresponding to each of the plurality of columns, the third signal line used to read out a signal from a third pixel group out of the plurality of pixels in the first scanning mode; and
a fourth signal line arranged corresponding to each of the plurality of columns, the fourth signal line used to read out a signal from a fourth pixel group out of the plurality of pixels in the second scanning mode,
wherein the potential control unit further supplies the predetermined potential to the fourth signal line in the period in which readout in the first scanning mode is performed and readout in the second scanning mode is not performed.

15. The photoelectric conversion device according to claim 14,
wherein the first pixel group and the second pixel group have sensitivity to light of a first color, and
wherein the third pixel group and the fourth pixel group have sensitivity to light of a second color.

16. The photoelectric conversion device according to claim 14, wherein the potential control unit supplies the predetermined potential to the second signal line at first time and supplies the predetermined potential to the fourth signal line at second time.

17. The photoelectric conversion device according to claim 16 further comprising an analog-to-digital conversion unit configured to convert an analog signal read out to the first signal line into a digital signal,
wherein the first time is before the analog-to-digital conversion unit converts an analog signal based on a reset state of the first pixel group into the digital signal, and
wherein the second time is later than the first time and before the analog-to-digital conversion unit converts an analog signal based on incident light on the first pixel group into the digital signal.

18. Equipment comprising:
the photoelectric conversion device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

19. The equipment according to claim 18, wherein the processing device processes image signals generated by a plurality of photoelectric conversion units and acquires distance information on a distance from the photoelectric conversion device to an object.
